(19) United States
(12) Patent Application Publication
(10) Pub. No.: US 2024/0208079 A1
(43) Pub. Date: Jun. 27, 2024

(54) LOCKING DEVICE FOR A GRIPPING OR CLAMPING APPARATUS

(71) Applicant: SCHUNK GmbH & Co. KG Spann- und Greiftechnik, Lauffen am Neckar (DE)

(72) Inventors: Michael Franz, Ilsfeld (DE); Ingo Haberzettl, Leingarte (DE); Gregory Kunz, Besigheim (DE); Daniel Layher, Kirchberg an der Murr (DE); Tobias Schleusener, Eppingen (DE)

(21) Appl. No.: 18/285,113

(22) PCT Filed: Mar. 22, 2022
(86) PCT No.: PCT/EP2022/057530

§ 371 Date: Jan. 2, 2024

(30) Foreign Application Priority Data
Mar. 31, 2021 (DE) 10 2021 108 259.5

(51) Int. Cl. B25J 15/02

(52) U.S. Cl. CPC B25J 15/0253

(57) ABSTRACT

A locking device (10, 70, 80) for a gripping or clamping apparatus (12) having two basic jaws (14) that can be moved closer to and away from one another, with a coupling member (26) which is movably coupled or can be movably coupled to the basic jaws (14) and is arranged so as to be rotatable about an axis of rotation (24). The coupling member (26) has a brake portion (30) on its lateral surface, and with at least one brake element (34) which can be displaced along a locking direction (38) running perpendicular to the axis of rotation (24) from a release position into a locking position in order to fix the coupling member (26). The brake element (34) engages tangentially on the brake portion (30) during displacement into the locking position.

The invention relates to a locking device for a gripping or clamping apparatus having two basic jaws which can be moved closer to and away from one another, with a coupling member which is movably coupled or can be movably coupled to the basic jaws and is arranged so as to be rotatable about an axis of rotation, wherein the coupling member has a brake portion on its lateral surface, and with at least one brake element which can be displaced along a locking direction extending perpendicular to the axis of rotation from a release position into a locking position in order to lock the coupling member. The invention also relates to a gripping or clamping apparatus with such a locking device.

Various types of locking devices are known from DE 10 2019 103 916 A1. FIGS. 12a and 12b show a locking device that shows features of the preamble of claim 1. There, two opposing brake elements in the form of brake jaws are provided, which act against a brake portion formed by the lateral surface of a brake disk. The brake jaws can be displaced along a common line, which extends along the locking direction perpendicularly to the axis of rotation and crossing the axis of rotation, i.e., radially to the brake portion, from the release position into the locking position.

Another locking device for a gripping or clamping apparatus is known from DE 10 2017 124 720 A1.

Gripping or clamping apparatuses without a braking and/or locking unit are known, for example, from DE 100 13 022 C2 or DE 101 38 685 C1.

Furthermore, it is known from DE 2011 084 177 A1 to provide a damping element between the drive of the gripping jaw and the gripping jaw. It is known from DE 10 2013 211 528 A1 to provide an elastic spring element for maintaining the gripping force.

A gripping or clamping unit with a transmission arrangement for maintaining a gripping force is known from DE 10 2019 118 672 B3. In this case, the gripping force is maintained by clamping a spring over the travel path of the gripping jaws, wherein no locking of the gripping jaws is possible without a clamped/gripped object.

The object of the invention is to provide a locking device and an associated gripping or clamping unit which is compact and with which the jaws can be braked and locked simply in a functionally reliable manner.

This object is achieved by means of a locking device having the features of claim 1.

Consequently, it is provided in particular that the brake element engages tangentially on the brake portion during displacement into the locking position. Due to the tangential engagement, the locking direction runs along a straight line, which is preferably spaced apart from the axis of rotation at least by the radius of the brake portion. Unlike in the known prior art according to DE 10 2019 103 916 A1, the brake element does not act radially against the brake portion but tangentially. As a result, a locking device which is compact can be realized on the one hand, since the brake element engages tangentially, i.e., laterally on the coupling member or its brake portion. In addition, unlike in the embodiment known from the prior art, the brake element can also be moved into the locking device at least in a limited manner as a result of or during the interaction with the brake portion.

It is advantageous if the brake portion is designed as a pinion and if the brake element has a toothed rack portion which interacts with the pinion in the locking position and which engages tangentially on the pinion. Such a rack section has at least one tooth with a tooth head, which releases the pinion in the release position and interacts with the pinion in the locking position, so that it, and thus also the coupling member, is locked. It is conceivable that the toothed rack portion also provides two or more teeth. In particular by providing the pinion and the toothed rack, a positive locking of the pinion, and thus of the coupling member, can be achieved.

It has been found to be particularly advantageous if two toothed rack portions are provided and if the pinion has an odd number of teeth which is selected such that only teeth of one of the two toothed racks can strike each tooth head of the pinion. It can thereby be ensured that, in each position of the pinion, a positive engagement of the one or other toothed rack between two teeth of the pinion is made possible. Should the rotational position of the pinion be such that one of the two toothed racks strikes a tooth head of the pinion, and thus cannot engage in a positive manner with the pinion, the other of the two toothed racks can engage in a form-fitting manner with the pinion and lock it. Advantageously, the configuration is further such that the toothed rack, which engages with the pinion, rotates the pinion at least to such an extent that the other toothed rack can also engage between two teeth of the pinion, so that ultimately both toothed racks lock the pinion and thus the coupling member.

It is further advantageous if the brake section is designed as a circular-cylindrical lateral surface and if the brake element engages tangentially on the circular-cylindrical lateral surface in the locking position. Depending on the choice of suitable materials, suitable friction coefficients result, which cause secure locking in the locking position. In particular, a force-locking and/or frictional locking of the coupling member can thereby be achieved.

The brake element can preferably be designed as a wedge finger, which has a wedge surface extending obliquely to the locking direction and acting in the locking position tangentially against the brake portion. By providing the wedge surface and by selecting a suitable wedge angle, a force amplification during displacement of the wedge finger into the locking position can be achieved.

Furthermore, it is conceivable that the brake element is designed as a wedge fork with two wedge surfaces extending obliquely to the locking direction and acting in the locking position tangentially against the brake portion. Such a wedge fork consequently comprises two wedge fingers which are displaced synchronously into the respective locking position. Both wedge surfaces of the wedge fork then engage in particular symmetrically and tangentially on the brake portion. As a result, a higher locking force can be achieved than when only one wedge finger is provided.

Furthermore, it is conceivable that the brake element is designed as a wedge fork with two wedge surfaces extending obliquely to the locking direction and acting in the locking position tangentially against the brake portion. Such a wedge fork consequently comprises two wedge fingers which are displaced synchronously into the respective locking position. Both wedge surfaces of the wedge fork then engage in particular symmetrically and tangentially on the brake portion. As a result, a higher locking force can be achieved than when only one wedge finger is provided.

Furthermore, it has been found to be advantageous if the wedge surfaces are designed in such a way that they are elastically flexibly deflected when gripping the brake portion and during further movement along the locking direction into the final locking position. As a result, contact of the wedge surfaces on the brake element can be achieved under pretension, so that a secure locking of the coupling member can be brought about even in the presence of manufacturing tolerances.

In this case, it is advantageous if at least one recess for realizing a flexure bearing is provided on the side of the wedge finger or the wedge fork facing away from the respective wedge surface. In this case, the recess can be geometrically designed such that the desired elastic flexibility for locking the coupling member is achieved by the flexure bearing formed with the recess.

Furthermore, it is advantageous if two brake elements are provided, which are arranged in a point-symmetrical manner with respect to the axis of rotation or in a mirror-symmetrical manner with respect to a plane extending perpendicular to the locking direction. A secure locking of the coupling member under stress with minimal installation space can be achieved by means of such a symmetrical arrangement.

The locking device according to the invention further advantageously provides that at least one brake piston and at least one spring element interacting with the brake piston are provided, wherein the displacement of the brake element from the release position into the locking position takes place due to the spring force of the spring element, and wherein the brake piston delimits a pressure chamber in such a way that, when the pressure chamber is pressurized, the brake element is forced out of the locking position against the spring force of the spring element into the release position. For better utilization of the installation space, it can further be provided that the at least one brake piston is arranged displaceably laterally next to the coupling member, parallel to the axis of rotation.

In this context, it has been found to be advantageous if a first, smaller brake piston and a second, larger brake piston are arranged on a piston rod, each delimiting a pressure chamber, wherein the larger brake piston faces the spring element and the smaller brake piston faces away from the spring element, and wherein a partition wall delimiting the pressure chamber of the larger brake piston is provided between the brake pistons. The two pressure chambers are preferably pressure-connected to one another. As a result, a force amplification for actuating the respective brake element can be achieved, since two brake pistons with a corresponding effective surface are available for providing the displacement of the respective brake element into the locking position and ultimately the braking force.

In this context, it is advantageous if the partition wall is supported on a housing stop on the side facing away from the larger piston. Such a housing stop can be designed as a circumferential housing shoulder. When the respective pressure chambers are pressurized, the partition wall is then forced against the housing stop so that it can be supported here. In the case of pressure loss and when the spring force is applied in particular to the larger brake piston, the partition wall is likewise acted upon into the housing stop. The partition wall can advantageously provide a sealed recess through which the piston rod extends. Due to such an arrangement of the partition wall, fastening means of the partition wall can be substantially omitted as such, resulting in a comparatively simple structure.

The aforementioned object is also achieved by a gripping or clamping apparatus which comprises a locking device according to the invention. The locking device can be attached as an attachment module to the gripping or clamping apparatus or be integrated into the gripping or clamping apparatus.

The gripping or clamping apparatus according to the invention can additionally provide that two basic jaws which can be moved closer to and away from one another are provided, wherein the basic jaws are each movably coupled to at least one working piston delimiting a working pressure chamber, wherein the working pistons each provide a coupling section, which is movably coupled to a coupling member which is arranged so as to be rotatable about an axis of rotation, wherein the coupling member of the gripping or clamping apparatus simultaneously forms or is rotationally coupled to the coupling member of the locking device. With such a gripping or clamping apparatus, the basic jaws are consequently driven pneumatically via the working pistons. By providing the coupling member, the movement of the working pistons can be locked by means of the locking device.

This also has the advantage that the position of the brake portion is held in the locking position and consequently the position of the gripping jaws of the gripping device can also be locked independently of a gripped object. This also prevents the jaws from snapping shut, which increases the safety of use of the gripping device. When a gripped object is removed from the gripping device in the locking position of the locking device, the snapping shut of the gripping jaws entails a risk of injury, as is the case in the prior art in DE 10 2019 118 672 B3.

Further details and advantageous embodiments of the invention can be found in the following description by which embodiments of the invention are described and explained in more detail.

In the drawings:

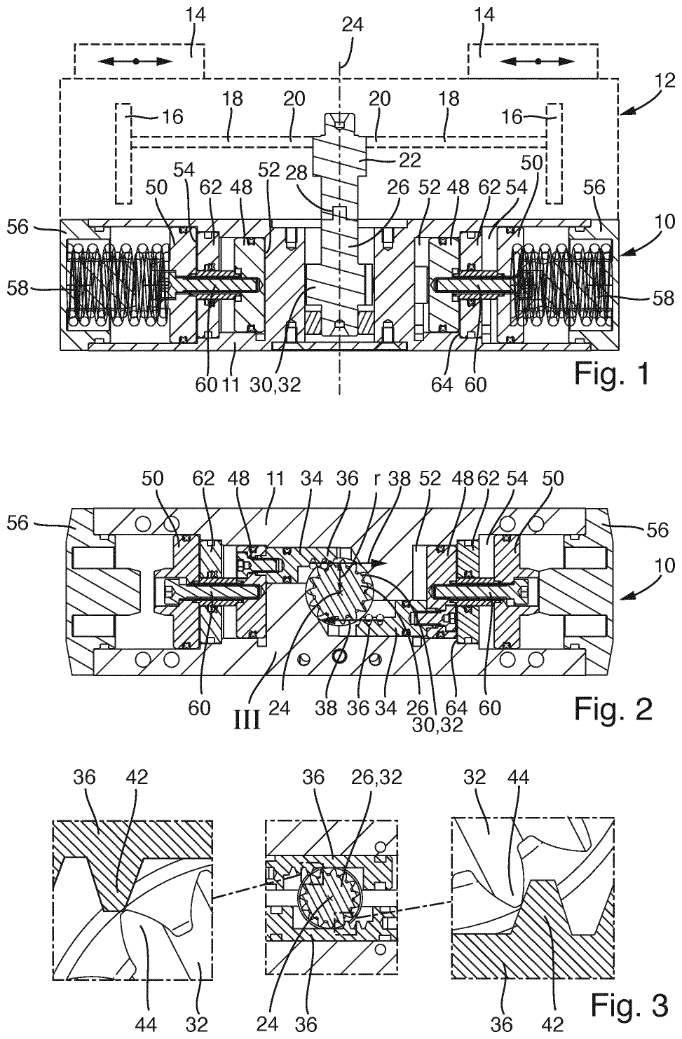

FIG. 1 shows a longitudinal section through a locking device according to the invention, which is provided on a gripping apparatus;

FIG. 2 shows a cross-section through the locking device according to FIG. 1;

FIG. 3 shows an enlarged view of the pinion shown in FIG. 2;

FIG. 4 shows a longitudinal section corresponding to FIG. 1 through a second locking device according to the invention;

FIG. 5 shows a cross-section through the locking device according to FIG. 3;

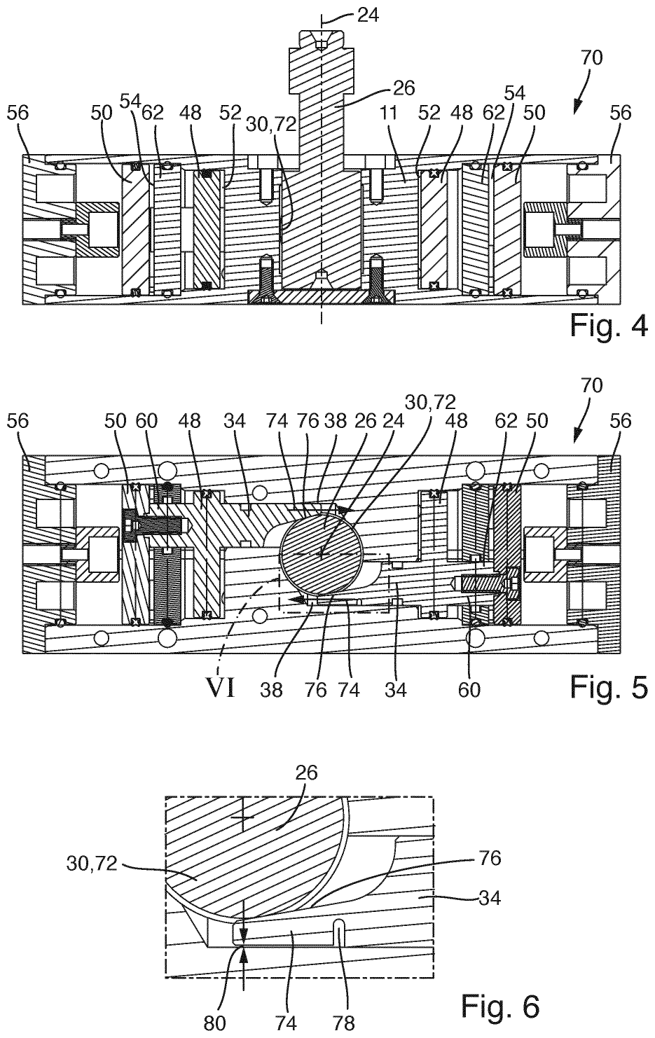

FIG. 6 shows an enlarged view of the cut-out VI in FIG. 5;

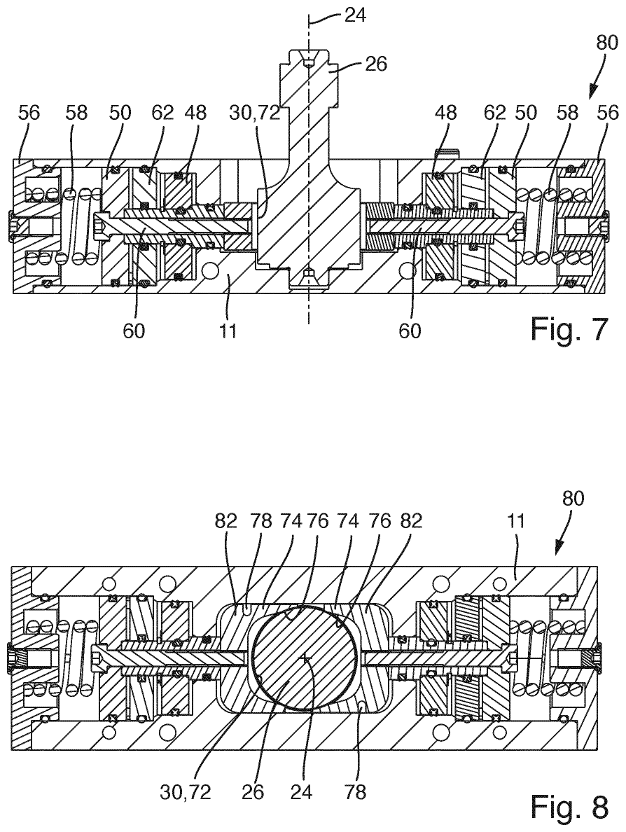

FIG. 7 shows a longitudinal section corresponding to FIG. 1 through a third locking device according to the invention; and

FIG. 8 shows a cross-section through the locking device shown in FIG. 5.

FIG. 1 shows a locking device 10 which is arranged on a gripping apparatus 12. The gripping apparatus 12 is shown only schematically and has two basic jaws 14 that can be moved closer to and away from each other. Furthermore, the gripping apparatus 12 has a coupling member 22 which is movably coupled to the basic jaws 14 and is rotatably arranged about an axis of rotation 24. In FIG. 1, two working pistons 16 are indicated in the gripping apparatus 12, each of which is movably coupled to one of the basic jaws 14. Travel of the working pistons 16 consequently results in travel of the basic jaws 14. The working pistons 16, or the piston rods 18 thereof, each provide a coupling portion 20, which is movably coupled to a coupling member 22 which is rotatably arranged about the axis of rotation 24. As a result, moving the pistons 16 closer to or moved away from one another leads to a rotational movement of the coupling member 22 about the axis 24. The movements of the two working pistons 16, and thus the movements of the basic jaws 14, are thus also synchronized via the coupling member 22.

The coupling member 22 can be designed as a pinion in the region in which it interacts with the coupling portions 20.

The piston portions 20 of the piston rods 18 can then be designed as toothed racks meshing with the pinion.

The gripping apparatus shown in FIG. 1 can correspond in particular to the gripping apparatuses shown in DE 10 2019 103 916 A1, in FIGS. 1 to 6. For further details and functional principles of the gripping apparatus 12, reference is made to FIGS. 1 to 6 with the associated description of the cited document.

As is clear from the section according to FIG. 1, the locking device 10 is designed as an attachment module which can be attached to the gripping apparatus 12. This has the advantage that the gripping apparatus 12 can also be operated without the locking device 10.

It is clear from the section according to FIG. 1 that the locking device 10 has a separate coupling member 26 which is rotatably mounted in its housing 11 and is rotationally coupled to the coupling member 22 of the gripping apparatus 12 via a coupling portion 28. In this context, it is conceivable that, instead of two individual coupling members 22, 26, a common coupling member can also be used, which is formed in particular integrally or as a single piece.

The coupling member 26 of the locking device 10 has on its lateral surface a brake portion 30, which in the embodiment according to FIGS. 1 and 2 is designed as a pinion 32. To lock the brake portion 30 or the pinion 32, two brake elements 34 are provided, as is clear from FIGS. 1 and 2. In the embodiment according to FIGS. 1 and 2, the brake elements 34 each have a toothed rack portion 36 with teeth 42, which are provided to interact with the pinion 32 and lock it in its position. The brake elements 34 are displaceable along a locking direction 38 running perpendicular to the axis of rotation 24 between a retracted release position into a locking position.

In this case, the toothed rack portions 36 engage tangentially on the brake portion 30 or on the pinion 32 in the locking position. As is clear from FIG. 2, the locking directions 38 each run along a straight line which is spaced apart from the axis of rotation 24 by the radius or the pitch circle radius r of the pinion 32. For illustration, the left brake element 34 is located in the locking position in the left half of FIGS. 1 and 2; in the right half of FIGS. 1 and 2, the right brake element 34 is located in the release position.

The pinion 32 has an odd number of teeth 44. As is clear from FIG. 3, this has the advantage that, when the brake elements 34 are displaced into the locking position only one tooth 42, if any, of a toothed rack 36 strikes a tooth head of a tooth 44 of the pinion 32 (FIG. 3, left image). It can thereby be ensured that one of the two rack portions 36 always comes into engagement with the pinion 32 in order to lock it or the coupling member 26, and thus ultimately the basic jaws 14 (FIG. 3, right image).

As is further clear from FIG. 2, the two brake elements 34 are arranged symmetrically to the axis of rotation 24. This has the advantage that both brake elements 34 engage symmetrically on the brake portion 30.

The brake elements 34 are each movably coupled to two brake pistons 48, 50. The brake pistons 48, 50 each delimit a pressure chamber 52, 54 which are arranged such that, when the pressure chambers 52, 54 are pressurized, the pistons 48, 50 are moved in the direction facing away from the pinion 26 and thus the brake elements 34 are displaced into their release position. In FIG. 1, spring elements 58 are provided between each brake piston 50 and a housing cover 56 and force the brake piston 50 towards the pinion 32, and thus force the brake element 34 into the locking position (in FIG. 2, the spring elements 58 are not shown for the sake of clarity). If a pressure drop takes place in the pressure chambers 52, 54, the brake pistons 48 and 50, and thus the respective brake element 34, are moved by the spring elements 58 into the locking position, as shown in the left half of the locking device in FIGS. 1 and 2. With sufficient pressurization of the pressure chambers 52, 54, the two pistons 48, 50, as shown in the right half of FIGS. 1 and 2, and thus the respective brake element 34, are forced out of the locking position into the release position. In this case, the pressure chambers 52, 54 are connected to the same pressure source as the pressure chambers, which are delimited by the drive pistons 16; in the case of an especially undesired pressure drop, the brake elements 34 are forced into the locking position by the spring elements 58 and the gripping jaws 14 are locked.

The two respective associated brake pistons 48 and 50 are connected to one another via a piston rod 60. Furthermore, an partition wall 62 in the form of a piston disk is provided between the respective associated brake pistons 48 and 50. The respective piston rod 60 extends through the respective partition wall 62 in a pressure-sealed manner.

The partition walls 62 are each supported on a housing stop 64 on the side facing away from the larger brake piston 50. The housing stop is designed as a circumferential annular shoulder. This embodiment has the advantage that the partition walls 62 can be inserted into the housing stop 64 without further fastening means. When the pressure chambers 52 and 54 are pressurized, the respective partition wall 62 is forced against the housing stop 64 due to the pressure in the pressure chamber 54. In the event of a pressure drop in the pressure chambers 52, 54, the spring elements 58 force the respective partition wall 62 against the respective housing stop 64.

The locking device 70 shown in FIGS. 4 and 5 substantially corresponds to the locking device 10 shown in FIGS. 1 and 2, wherein corresponding components are denoted by corresponding reference numerals. Unlike the locking device 10, a common coupling member 26 is provided in the case of the locking device 70 for a gripping apparatus (not shown in FIGS. 4 and 5) and for the locking device 70.

The locking device 70 further differs from the locking device 10 in that the brake portion 30 is not designed as a pinion, but rather as a rotationally symmetrical lateral surface, and in the embodiment shown as a circular-cylindrical lateral surface 72. Corresponding to FIG. 2, spring elements 58 between the housing covers 56 and the respectively outer brake pistons 50 are not shown in FIGS. 3 and 4. Furthermore, the brake elements 34 are not designed as toothed rack portions in the locking device 70, but rather as a wedge fingers 74. The wedge fingers 74 each have a wedge surface 76 which runs obliquely to the locking direction 38 and encloses an acute angle with the locking direction 38. When the brake elements 34 are displaced in the locking direction 38, the wedge surfaces 76 of the brake elements 34 consequently engage tangentially at the brake portion 30 or the circular-cylinder lateral surface 72.

As is clear from the enlarged detail according to FIG. 6, the wedge fingers 74 have a recess 78 on the side facing away from the wedge surfaces 76, so that the wedge surfaces 76 or the wedge fingers 74 are elastically flexibly deflected when engaged at the brake portion 30 and during further movement along the locking direction 38. By providing the recess 78, a type of flexure bearing is consequently realized. In order to enable a deflection of the free end of the wedge finger 74, the portion of the respective wedge finger 74 that is located between the free end of the wedge finger 74 and the recess 78 is set back towards the brake portion 30 by the dimension 79.

Corresponding to the locking device 10, in the case of a pressure drop of the pressure in the pressure chambers 52, 54 in the locking device 70, the two brake elements 34 or the wedge surfaces 76 thereof are moved along the locking direction 38 from their release position into the locking position due to the spring elements (not shown in FIGS. 4 and 5); the wedge surfaces 76 engage tangentially, non-positively on the coupling element 26 or its brake portion 30.

FIGS. 7 and 8 show a further locking device 80 according to the invention, which substantially corresponds to the locking device 70 according to FIGS. 4 and 5, wherein corresponding components carry corresponding reference signs.

In contrast to the locking device 70, the locking device 80 has two wedge forks 82 as brake elements 34, each of which has two wedge fingers 74 with wedge surfaces 76 running obliquely to the locking direction 38. The locking device 80 consequently does not only engage with two wedge surfaces 76 on the brake portion 30, but with a total of four wedge surfaces 76. An increased locking effect can be achieved thereby. Corresponding to the locking device 70, recesses 78 are provided on the wedge forks 82 or on one wedge finger 74 of each wedge fork 82 in order to enable an elastically flexible deflection of the respective wedge fingers 74, corresponding to the locking device 70.

1. A locking device (10, 70, 80) for a gripping or clamping apparatus (12) having two basic jaws (14) that can be moved closer to and away from one another,
with a coupling member (26) which is movably coupled or can be movably coupled to the basic jaws (14) and is arranged so as to be rotatable about an axis of rotation (24),
wherein the coupling member (26) has a brake portion (30) on its lateral surface, and with at least one brake element (34) which can be displaced along a locking direction (38) running perpendicular to the axis of rotation (24) from a release position into a locking position in order to fix the coupling member (26), characterized in that that the brake element (34) engages tangentially on the brake portion (30) during displacement into the locking position.

2. The locking device (10) according to claim 1, characterized in that the brake portion (30) is designed as a pinion (32) and that the brake element (34) has a toothed rack portion (36) which interacts with the pinion (32) in the locking position and engages tangentially on the pinion (32).

3. The locking device (10) according to claim 2, characterized in that two toothed rack portions (36) are provided and that the pinion (32) has an odd number of teeth which is selected such that only one of the two toothed rack portions (36) can strike one tooth head (44) of the pinion (32) in each case.

4. The locking device (70, 80) according to claim 1, characterized in that the brake portion (30) is designed as a rotationally symmetrical lateral surface (72) and that the brake element (34) engages tangentially on the lateral surface (72) in the locking position.

5. The locking device (10, 70, 80) according to claim 1, characterized in that the brake element (34) is designed as a wedge finger (74) with a wedge surface (76) running obliquely to the locking direction (38) and acting tangentially against the brake portion (30) in the locking position.

6. The locking device (70, 80) according to claim 5, characterized in that the brake element (34) is designed as a wedge fork (82) with two wedge surfaces (76) running obliquely to the locking direction (38) and acting tangentially against the brake portion (30) in the locking position.

7. The locking device (70, 80) according to claim 5, characterized in that the wedge surfaces (76) are designed such that they are elastically flexibly deflected when they engage with the brake portion (30) and during further movement along the locking direction (38).

8. The locking device (70, 80) according to claim 7, characterized in that a recess (78) for realizing a flexure bearing has on the side facing away from the respective wedge surfaces (76).

9. The locking device (10, 70, 80) according to claim 1, characterized in that two brake elements (34) are provided, which are arranged in a point-symmetrical manner with respect to the axis of rotation (24) or in a mirror-symmetrical manner with respect to a plane running perpendicular to the locking direction.

10. The locking device (10, 70, 80) according to claim 1, characterized in that at least one brake piston (46, 48) and at least one spring element (58) interacting with the brake piston (46, 48) are provided, wherein the displacement of the brake element (34) from the release position into the locking position takes place due to the spring force of the spring element (58), and wherein the at least one brake piston (46, 48) delimits a pressure chamber (52, 54) in such a way that, when the pressure chamber (52, 54) is pressurized, the brake element (34) is forced from the locking position into the release position against the spring force of the spring element (70).

11. The locking device (10, 70, 80) according to claim 10, characterized in that a first brake piston (48) and a second brake piston (50) are arranged on a piston rod (60), each of which delimit a pressure chamber (52, 54), that the second brake piston (50) faces the spring element (58) and the first brake piston (48) faces away from the spring element (58), and that a partition wall (62) delimiting the pressure chamber (54) of the second piston (50) is provided between the brake pistons (48, 50).

12. The locking device (10, 70, 80) according to claim 10, characterized in that the partition wall (62) is supported on a housing stop (64) on the side facing away from the second brake piston (50).

13. A gripping or clamping apparatus (12) comprising a locking device (10, 70, 80) according to claim 1.

14. The gripping or clamping apparatus (12) according to claim 13, characterized in that two basic jaws (14) which can be moved closer to and away from one another are provided, wherein the basic jaws (14) are each movably coupled to at least one working piston (16) delimiting a working pressure chamber, wherein the working pistons (16) each provide a coupling portion (20) which is movably coupled to a coupling member (22, 26) which is arranged so as to be rotatable about an axis of rotation (24), wherein the coupling member (22) of the gripping or clamping apparatus (12) simultaneously forms or is rotationally coupled to the coupling member (26) of the locking device.
